(19) United States
(12) Patent Application Publication
(10) Pub. No.: US 2016/0132478 A1
(43) Pub. Date: May 12, 2016

(54) METHOD OF DISPLAYING MEMO AND DEVICE THEREFOR

(71) Applicant: Samsung Electronics Co., Ltd., Suwon-si (KR)

(72) Inventors: Ho-young JUNG, Hwaseong-si (KR); Dong-hyuk LEE, Seoul (KR); Jae-kyung KWAK, Ansan-si (KR); Do-hyeon KIM, Suwon-si (KR); Sang-ho KIM, Hwaseong-si (KR); Jeong-wan PARK, Seoul (KR); Dong-chang LEE, Suwon-si (KR); Wong-hee LEE, Suwon-si (KR); Jae-woong LEE, Suwon-si (KR); Seong-taek HWANG, Pyeongtaek-si (KR)

(21) Appl. No.: 14/936,220

(22) Filed: Nov. 9, 2015

(30) Foreign Application Priority Data
Nov. 10, 2014 (KR) 10-2014-0155514

(51) Int. Cl. G06F 17/24; G06F 3/0484; G06F 17/21; G06F 3/0488

(52) U.S. Cl. CPC G06F 17/241; G06F 3/04883; G06F 17/243; G06F 3/04842; G06F 3/04845; G06F 17/212

(57) ABSTRACT

A method of displaying a memo is provided. The method includes displaying an electronic document and a memo for the electronic document, obtaining relative position information of the memo on the electronic document, and displaying the memo on the electronic document based on the obtained position information depending on a display state of the electronic document.

### CROSS-REFERENCE TO RELATED APPLICATION(S)

This application claims the benefit under 35 U.S.C. §119(a) of a Korean patent application filed on Nov. 10, 2014 in the Korean Intellectual Property Office and assigned Serial number 10-2014-0155514, the entire disclosure of which is hereby incorporated by reference.

### TECHNICAL FIELD

The present disclosure relates to a method of displaying a memo and a device therefor.

### BACKGROUND

A mobile terminal may be configured to perform various functions. Examples of the various functions include a data and voice communication function, a function of capturing a photo or a moving picture by using a camera, an audio storing function, a reproduction function with respect to a music file performed via a speaker system, a display function with respect to an image or a video, etc.

Some mobile terminals include an additional function that may execute games, and other mobile terminals may be implemented as multimedia apparatuses. Furthermore, as development of smartphones accelerates, development and use of various applications also increase.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and device for displaying a memo.

Another aspect of the present disclosure is to provide a method and device for displaying a memo corresponding to an electronic document.

Additional aspects will be set forth in part in the description which follows and, in part, will be apparent from the description, or may be learned by practice of the presented embodiments.

In accordance with an aspect of the present disclosure, a method of displaying a memo is provided. The method includes displaying an electronic document and a memo corresponding to the electronic document, obtaining relative position information of the memo on the electronic document, and displaying the memo on the electronic document based on the obtained relative position information depending on a display state of the electronic document.

The relative position information of the memo may include identification information of an object corresponding to the memo among objects included in the electronic document.

The method may further include receiving a gesture for dividing the memo, determining at least one reference line, and generating a divided memo according to the determined at least one reference line based on the received gesture, when the at least one reference line is located on an object included in the memo, dividing the object into a plurality of groups based on the at least one reference line according to a minimum division unit of the object, and inserting the divided object into the divided memo for each group based on the at least one reference line.

The minimum division unit of the object may include at least one of a letter of text and handwriting content, a word, a sentence, a paragraph unit, and an image file unit.

The method may further include receiving a gesture for merging a plurality of memos, obtaining at least one object included in the plurality of memos based on the received gesture, and inserting the obtained at least one object into a second memo into which the plurality of memos merge.

The method may further include obtaining an object to insert into the memo from the electronic document, comparing a size of the object with a size of an empty region of the memo into which the object is insertable, adjusting at least one of the size of the memo and the size of the object such that the object is inserted into the memo based on a result of the comparing, and inserting the object into the memo.

The method may further include obtaining an object to insert into the memo from the electronic document, comparing a size of the object with a size of an empty region of the memo into which the object is insertable, generating a new memo based on a result of the comparing, dividing the object into a plurality of groups according to a minimum division unit of the object, and inserting the divided object into the empty region of the memo and the new memo for each group.

The method may further include obtaining an object to insert into the memo from the electronic document, and inserting the obtained object into the memo. Position information of the memo may include identification information of an object of the electronic document that corresponds to the inserted object.

The method may further include obtaining an object to insert into the memo from the electronic document, comparing a size of the object with a size of an empty region of the memo into which the object is insertable, adjusting a size of the object based on the size of the empty region of the memo, and inserting the size-adjusted object into the empty region of the memo.

In accordance with another aspect of the present disclosure, a method of displaying a memo is provided. The method includes displaying a memo corresponding to at least one electronic document, selecting the memo, obtaining preview information of an electronic document that corresponds to the selected memo, obtaining relative position information of the selected memo on the electronic document, and displaying a preview of the electronic document including the relative position information based on the obtained preview information.

The displaying of the preview may include determining a predetermined region of the electronic document based on the relative position information and displaying a preview for the determined predetermined region of the electronic document including the relative position information.

The displaying of the at least one memo may include displaying the memo by minimizing an empty space included in the memo and maximizing at least one object included in the memo, when the at least one object is displayed having a reference size or less, determining whether the memo includes an important object, and when the memo includes the important object, enlarging the important object to the reference size or more and displaying the enlarged important object in a display area of the memo.

The displaying of the at least one memo may include when content included in the memo includes an important mark, determining an appearance of the memo depending on the importance of the important mark, and displaying the memo based on a result of the determining.

The displaying of the at least one memo may include obtaining a frequency of memo selection, which is a frequency by which the memo is selected and displayed, and determining an appearance of the memo according to the obtained frequency of memo selection, and displaying the memo based on a result of the determining.

In accordance with another aspect of the present disclosure, a device is provided. The device includes a display unit configured to display an electronic document and a memo corresponding to the electronic document, and a controller configured to control the display unit to obtain relative position information of the memo on the electronic document, and display the memo on the electronic document based on the obtained relative position information depending on a display state of the electronic document.

In accordance with another aspect of the present disclosure, a device is provided. The device includes a display unit configured to display a memo corresponding to at least one electronic document, and a controller configured to control the display unit to select the memo, obtain preview information of an electronic document that corresponds to the selected memo, obtain relative position information of the selected memo on the electronic document, and display a preview of the electronic document including the relative position information based on the obtained preview information.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings in which:

FIG. 1 is a view explaining a method of displaying a memo, according to an embodiment of the present disclosure;

FIG. 2 is a flowchart illustrating a method of displaying a memo, according to an embodiment of the present disclosure;

FIG. 3 is a view illustrating an example of displaying a memo, according to an embodiment of the present disclosure;

FIG. 4 is a flowchart illustrating a method of dividing a memo, according to an embodiment of the present disclosure;

FIG. 5 is a view illustrating an example of dividing a memo, according to an embodiment of the present disclosure;

FIG. 6 is a view illustrating an example of a method of dividing a memo in the case where a reference line is located on an object, according to an embodiment of the present disclosure;

FIG. 7 is a flowchart illustrating a method of merging memos, according to an embodiment of the present disclosure;

FIG. 8 is a view illustrating an example of merging memos, according to an embodiment of the present disclosure;

FIG. 9 is a flowchart illustrating a method of inserting an object into a memo, according to an embodiment of the present disclosure;

FIG. 10 is a view illustrating an example of a method of inserting an object into a memo, according to an embodiment of the present disclosure;

FIG. 11 is a view illustrating an example of inserting an object into a memo, according to an embodiment of the present disclosure;

FIG. 12 is a view illustrating an example of displaying a memo icon, according to an embodiment of the present disclosure;

FIG. 13 is a flowchart illustrating a method of displaying a memo and an electronic document corresponding to the memo, according to an embodiment of the present disclosure;

FIG. 14 is a view illustrating an example of displaying a preview of an electronic document, according to an embodiment of the present disclosure;

FIG. 15 is a flowchart illustrating a method of displaying a preview of an electronic document, according to an embodiment of the present disclosure;

FIG. 16 is a flowchart illustrating a method of displaying a memo including an object, according to an embodiment of the present disclosure;

FIG. 17 is a view illustrating an example of displaying a memo, according to an embodiment of the present disclosure;

FIG. 18 is a view illustrating an example of displaying a memo including an important object, according to an embodiment of the present disclosure;

FIG. 19 is a view illustrating an example of displaying a memo including an important mark, according to an embodiment of the present disclosure;

FIG. 20 is a view illustrating an example of displaying a memo, according to an embodiment of the present disclosure;

FIG. 21 is a view illustrating an example of enlarging a memo and displaying the same, according to an embodiment of the present disclosure;

FIG. 22 is a block diagram for explaining an example in which a memo and information regarding an electronic document are stored, according to an embodiment of the present disclosure; and

FIGS. 23 and 24 are block diagrams for explaining the constructions of devices 2300 and 2400 according to various embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As the terms used herein, so far as possible, widely-used general terms are selected in consideration of functions in the present disclosure; however, these terms may vary according to the intentions of those of ordinary skill in the art, the precedents, or the appearance of new technology. Also, in some cases, there may be terms that are arbitrarily selected by the applicant, and the meanings thereof will be described in detail in the corresponding portions of the description of the present disclosure. Therefore, the terms used herein are not simple titles of terms and should be defined based on the meanings thereof and the overall description of the present disclosure.

It will be understood that the terms “comprises”, “includes”, and “has”, when used herein, specify the presence of stated elements, but do not preclude the presence or addition of other elements, unless otherwise defined. Also, the terms “unit” and “module” used herein represent a unit for processing at least one function or operation, which may be implemented by hardware, software, or a combination of hardware and software.

Throughout the specification, the term “touch input” may refer to a gesture that is performed by the user on a touchscreen to control the device 100. For example, the touch input described herein may include Tap, Touch & Hold, Double Tap, Drag, Panning, Flick, Drag & Drop, Pinch, Swipe, etc.

“Tap” may refer to a user's operation of touching the screen with a finger or a touch tool (e.g., an electronic pen) and then immediately lifting it from the screen without moving the finger or the touch tool horizontally.

“Touch & Hold” may refer to a user's operation of touching the screen with a finger or a touch tool (e.g., an electronic pen) and then holding the touch input for a critical time (e.g., two seconds) or more. For example, “Touch & Hold” may correspond to the case where a time difference between a Touch-In time and a Touch-Out time is equal to or greater than the critical time (e.g., two seconds). When the touch input is held for the critical time or more, a visual, auditory, or tactile feedback signal may be provided so that the user may recognize whether the touch input is “Tap” or “Touch & Hold.” The critical time may vary according to various embodiments of the present disclosure.

“Double Tap” may refer to a user's operation of touching the screen with a finger or a touch tool (e.g., an electronic pen) successively two times.

“Drag” may refer to a user's operation of touching the screen with a finger or a touch tool and then shifting the finger or the touch tool to another position on the screen while maintaining the touch. By performing a drag operation, an object may be shifted, or a panning operation, which is described below, may be performed.

“Panning” may refer to the case where the user performs a drag operation without selecting an object. Since “Panning” does not involve selecting an object, an interactive screen shifts to a next page or an object group shifts within the interactive screen, instead of the object being shifted within the interactive screen.

“Flick” may refer to a user's operation of dragging at a critical speed (e.g., 100 pixel/s) or more with a finger or a touch tool. “Drag (or Panning)” may be discriminated from “Flick” based on whether the shift speed of the finger or the touch tool is higher than the critical speed (e.g., 100 pixel/s).

“Drag & Drop” may refer to a user's operation of dragging and dropping an object to a predetermined position on the screen with a finger or a touch tool.

“Pinch” may refer to a user's operation of shifting two fingers in different directions while touching the screen with both fingers. “Pinch” may be a gesture for magnifying (Pinch Open) or demagnifying (Pinch Close) an object or a page, and a magnification value or a demagnification value may be determined according to the distance between the two fingers.

“Swipe” may refer to a user's operation of shifting a finger or a touch tool by a predetermined distance in a horizontal or vertical direction while touching an object on the screen with the finger or the touch tool. A diagonal shift may not be recognized as a swipe event.

“Hovering” may refer a user's operation of performing an input with a finger or a touch tool separated by a predetermined distance from a screen without the finger or the touch tool actually touching the screen.

Various embodiments of the present disclosure will be described below in detail with reference to the accompanying drawings so that those of ordinary skill in the art may easily implement the present disclosure. The present disclosure may, however, be embodied in many different forms and should not be construed as being limited to the embodiments set forth herein. In addition, portions irrelevant to the description of the present disclosure will be omitted in the drawings for a clear description of the present disclosure, and like reference numerals will denote like elements throughout the specification.

Expressions such as “at least one of,” when preceding a list of elements, modify the entire list of elements and do not modify the individual elements of the list.

Hereinafter, the present disclosure will be described more fully with reference to the accompanying drawings, in which various embodiments of the present disclosure are shown.

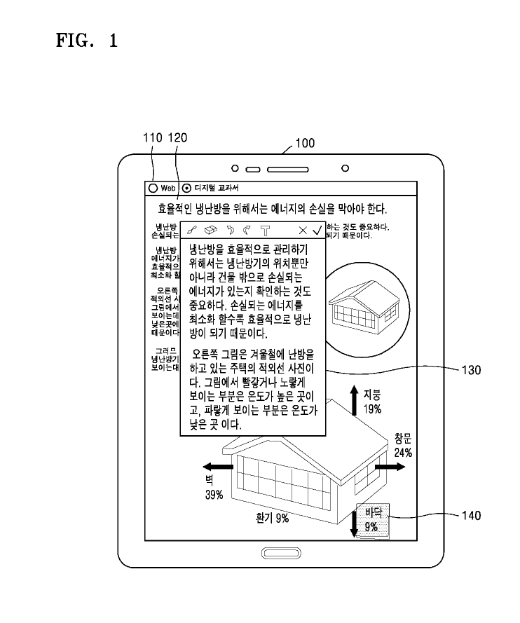

FIG. 1 is a view explaining a method of displaying a memo according to an embodiment of the present disclosure.

Referring to FIG. 1, a device 100 may be a display device that may display a memo according to an embodiment of the present disclosure. For example, the device 100 described in the present specification may be a mobile phone, a smartphone, a laptop computer, a tablet personal computer (PC), an electronic book terminal, a digital broadcasting terminal, a personal digital assistant (PDA), a portable multimedia player (PMP), a navigation device, a Moving Picture Experts Group phase 1 or phase 2 (MPEG-1 or MPEG-2) audio layer 3 (MP3) player, a digital camera, a wearable device (for example, glasses, a wrist watch, and a ring), etc., but is not limited thereto.

Throughout the specification, a ‘memo’ may mean a simple type document including handwriting content, text, or an image. The memo may include content such as handwriting content, text, an image, voice, and a moving picture, but is not limited thereto and may include various types of information. Various types of information such as content included in the memo are referred to as an object included in the memo hereinafter.

The handwriting content may mean content obtained by converting a user's analog handwriting input into digital information. For example, the handwriting content may include a handwriting image, handwriting text, etc. drawn on a digital apparatus, but is not limited thereto.

The handwriting content according to an embodiment may be a set of strokes input in a predetermined time sequence. A “stroke” may mean one trace in which an input tool performs drawing while maintaining a touch from a point where the input tool is touched onto the device 100. For example, in ‘3x+6y=5’, in the case where a user writes each of 3, 6, and y one at a time while maintaining a touch, each of 3, 6, and y may configure one stroke. In the case of ‘+’, since a user draws ‘−’ first and then draws ‘|’, each of ‘−’ and ‘|’ may configure one stroke. According to an embodiment of the present disclosure, one stroke may configure one letter or symbol, or a combination of a plurality of strokes may configure one letter or symbol.

Also, throughout the specification, an ‘electronic document’ may mean an electronic document including various types of content. For example, the electronic document may include documents with extensions such as portable document format (.PDF), hangul word processor (.HWP), and Powerpoint™ (.PPT), a Word™ document, a flash file, etc., but is not limited thereto, and may include various types of documents or files such as a web page, an image, a moving picture, etc.

Referring to FIG. 1, a memo 130 may be configured to be of a simple type that may display memo content, and be displayed on a portion of a display screen 110 of the device 100. The memo 130 may be generated by a user input, but is not limited thereto, and may be automatically generated according to information received from an external device or a predetermined algorithm. For example, when an event occurs for an electronic document, a memo including the occurred event information may be automatically generated. The memo 130 according to an embodiment may correspond to at least one electronic document 120, and include various types of information related to the corresponding electronic document 120.

According to an embodiment of the present disclosure, in the case where the electronic document 120 is displayed on the display screen 110 of the device 100, the memo 130 corresponding to the electronic document 120 may be displayed at a relative position on the electronic document 120. For example, the memo 130 may be displayed based on relative position information of the memo 130 depending on a display state of the electronic document 120. For example, in the case where the electronic document 120 is scrolled or enlarged or reduced, the memo 130 may be displayed at a moved position depending on a relative position of the memo 130 on the electronic document 120.

The relative position information of the memo 130 may be identified according to identification information of an object included in the electronic document 120 corresponding to the memo 130. In the case where the memo 130 corresponds to an object included in the electronic document 120, the device 100 may display the memo 130 at a position where the object corresponding to the memo 130 is displayed by using the identification information of the object. Therefore, the memo 130 according to an embodiment may be moved and displayed together with the object in the case where the object displayed on the screen moves with time or the position of the object is modified by a user input.

In addition, the relative position information of the memo 130 may include coordinate information of the memo 130 on the electronic document 120 instead of the identification information of the object.

Throughout the specification, an ‘object’ may mean a letter or a sentence of text, a partial region of an image, etc., but is not limited thereto, and may mean a partial region of the electronic document 120 that may be displayed on the display screen 110 of the device 100. The ‘object’ may be included in the memo 130 as well as the electronic document 120. That is, the memo 130 may include at least one object.

According to an embodiment of the present disclosure, the device 100 may display a memo icon 140 on the electronic document 120 based on the position information of the memo 130 instead of displaying the memo 130 including an object. The memo icon 140 may include information that may identify the memo icon 140 such as some content included in the memo 130 corresponding to the memo icon 140, a category to which the memo 130 belongs, or a title of the memo 130. Alternatively, the memo icon 140 may include a portion of an object corresponding to the memo 130. The memo icon 140 may be displayed in the form of a small icon on the electronic document 120 as illustrated in FIG. 1. The memo icon 140 may be displayed on a predetermined position on the electronic document 120 according to the relative position information of the memo 130 corresponding to the memo icon 140.

The device 100 may represent that the memo 130 corresponding to the electronic document 120 exists at a position where the memo icon 140 is displayed by displaying the memo icon 140 in the form of an icon smaller than the memo 130. When a user input is received with respect to the memo icon 140, the device 100 may display a memo corresponding to the memo icon 140. For example, when an input of tapping the memo icon 140 is received, the memo corresponding to the memo icon 140 may be displayed on the display screen 110 like the memo 130 illustrated in FIG. 1.

The memo 130 or the memo icon 140 displayed on the electronic document may be displayed to be semitransparent so that content of the electronic document 120 may be recognized.

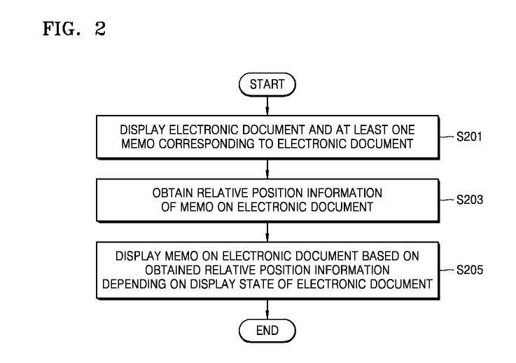

Hereinafter, a method of displaying, at the device 100, a memo is described with reference to FIG. 2.

FIG. 2 is a flowchart illustrating a method of displaying a memo according to an embodiment of the present disclosure.

Referring to FIG. 2, in operation S201, the device 100 may display an electronic document and at least one memo corresponding to the electronic document. The displaying of the at least one memo at the device 100 may include displaying the above-described memo icon 140 (see FIG. 1) as well as the memo. Hereinafter, a description of the case where a ‘memo’ is displayed is given for convenience of description. In operation S201, the device 100 may display at least one memo or memo icon together with an electronic document.

According to an embodiment of the present disclosure, in the case where a memo corresponding to the electronic document already exists, when the electronic document is displayed, the memo corresponding to the electronic document may be displayed together with the document. In addition, in the case where a new memo is generated according to a user input, in operation S201, the new memo generated according to the user input may be displayed on the electronic document.

In operation S203, the device 100 may obtain relative position information of the memo displayed in operation S201 on the electronic document. The memo according to an embodiment may correspond to at least one electronic document and include relative position information on the corresponding electronic document.

The device 100 may obtain the relative position information of the memo on the electronic document in operation S203. For example, the device 100 may obtain relative coordinate information on the electronic document or identification information of an object that may correspond to the memo as the position information of the memo. The relative position information of the memo may be determined depending on the position of the memo displayed on the screen in operation S201.

According to an embodiment of the present disclosure, in the case where a memo corresponding to the electronic document exists already, the device 100 may obtain relative position information of the already existing memo set in advance. In the case where a new memo is generated according to a user input, the device 100 may obtain a position where the new memo is generated as relative position information of the new memo. For example, the device 100 may obtain a position where a user input for generating a new memo is received on the electronic document as relative position information of the new memo.

The relative position information of the memo may include at least one of relative coordinate information of (x,y) on the electronic document and identification information of an object included in the electronic document. The relative coordinate information representing the position of the memo includes relative coordinate information based on the electronic document, not absolute coordinate information based on the display screen 110, so that the device 100 may move the memo depending on a display state of the electronic document. Therefore, among coordinate information representing the position of the memo, values x and y may have the horizontal length and a vertical length of the electronic document as maximum values, respectively.

In addition, in the case where the memo moves on the electronic document according to a user input, the device 100 may obtain the relative position information of the memo based on a position where the memo finally exists. For example, the device 100 may obtain the relative position information of the memo depending on a position where a reference point of the memo exists.

In the case where the relative position information includes identification information of an object, the object that may correspond to the memo may include a letter, a word, a sentence, a paragraph of text, an entire or partial region of an image, an icon, a hyperlink, etc. The device 100 may determine a position where the device is to display the memo on the electronic document by identifying an object based on the identification information of the object included in the relative position information of the memo.

The device 100 may obtain position information of the memo by determining an object corresponding to the memo and identifying an object corresponding to the memo. For example, the device 100 may obtain position information of the memo by identifying an object displayed at a place where a reference point of the memo is located and obtaining identification information of the identified object. The reference point of the memo may be determined as the center of the memo or an upper portion on one side of the memo, for example.

The device 100 may identify an object based on at least one of an identify unit of an object set in advance and a user input in order to obtain identification information of the object among the position information of the memo. For example, in the case where it is set that an object is identified on a word basis of text, the device 100 may determine text on a word basis included in an electronic document where the reference point of the memo is located, and obtain the identification information of the object by identifying information of the determined word of the text. In addition, the device 100 may obtain the position information of the memo by determining an object corresponding to the memo according to a user input, and obtaining identification information of the determined object.

The identification information of the object may include position information that may identify the object in the electronic document. In the case where the position information of the memo includes the identification information of the object, the device 100 may also move the memo as the object corresponding to the memo moves on the electronic document. For example, in the case where the position of the object changes as the object corresponding to the memo is modified, enlarged, or reduced, the memo may be moved and displayed according to the changed position of the object. Also, in the case where the object corresponding to the memo is deleted, the memo is also deleted, or the identification information of the object among the position information of the memo may be also deleted.

For example, in the case where the object corresponding to the memo is deleted, the device 100 may delete the identification information of the object among the position information of the memo or modify the position information of the memo as a default position. The default position information includes information by which the position information of the memo may be set as default when the position information of the memo is not set. For example, the default position information may include relative coordinate information at an upper left end or central point of the electronic document.

In operation S205, the device 100 may display the memo on the electronic document based on the relative position information obtained in operation S203 depending on a display state of the electronic document. The display state of the electronic document in operation S205 may include a state in which the electronic document is scrolled, enlarged, or reduced, but is not limited thereto, and may include various display types.

According to an embodiment of the present disclosure, the device 100 may move and display the memo depending on the position information of the memo when the electronic document is scrolled, enlarged, or reduced. In the case where the memo corresponds to an object displayed on the electronic document, the device 100 may move and display the memo when the electronic document is scrolled, enlarged, or reduced so that the memo may be displayed at a position where an object corresponding to the memo is displayed.

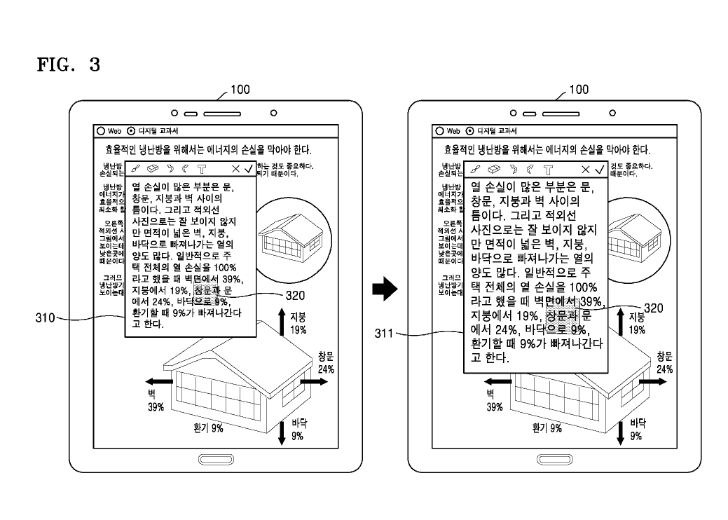

FIG. 3 is a view illustrating an example of displaying a memo according to an embodiment of the present disclosure.

Referring to FIG. 3, the device 100 may display a memo or a memo icon 320 corresponding to an electronic document 310. In the case where the electronic document 310 is enlarged and displayed (311), the device 100 may move and display the memo icon 320 on the electronic document 310 according to relative position information of the memo corresponding to the memo icon 320.

For example, in the case where the relative position information of the memo includes coordinate information (x,y) on the electronic document 310, the device 100 may determine a display position of the memo icon 320 on the electronic document 310 enlarged based on ratios in which the electronic document 310 is enlarged in horizontal and vertical directions. For example, in the case where ratios in which the electronic document 310 is enlarged in the horizontal and vertical directions are “a” times and “b” times, respectively, the device 100 may determine a value (x*a, y*b) as coordinate information of the memo icon 320 on the enlarged electronic document 311.

Alternatively, in the case where the relative position information of the memo includes the identification information of the object included in the electronic document 310, the device 100 may determine a display position of the memo icon 320 based on the position of the object included in the enlarged electronic document 311. In the case where the position information of the memo icon 320 includes identification information of a ‘window’ as illustrated in FIG. 3, the memo icon 320 may be displayed at a position where the ‘window’ of the electronic document 310 is displayed. The device 100 may obtain information for the position at which the ‘window’ of the enlarged electronic document 311 is displayed based on identification information of the ‘window’, and determine a display position of the memo icon 320 based on the position where the ‘window’ of the enlarged electronic document 311 is displayed.

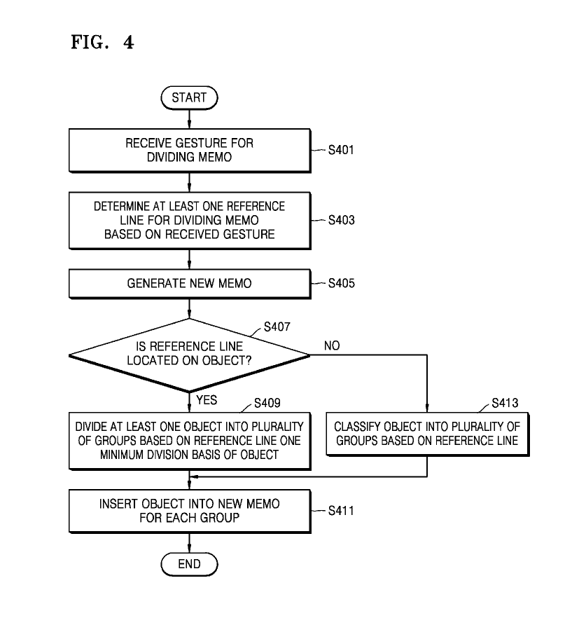

FIG. 4 is a flowchart illustrating a method of dividing a memo according to an embodiment of the present disclosure. A memo that may be divided according to the embodiment of FIG. 4 may include a memo that may be displayed together with the electronic document by the device 100 according to the embodiment of FIG. 2.

Referring to FIG. 4, in operation S401, the device 100 may receive a gesture for dividing a memo. Exemplarily, the device 100 may receive a gesture for dividing a memo displayed on the display screen 110. For example, the gesture for dividing the memo may include a drag operation or a motion operation directed from one side of the memo to the opposite side. The drag operation may include an operation in which a touch input is successively received along a predetermined path, and the motion operation may include a motion operation representing a gesture for dividing the memo. The motion operation may include a motion operation that moves along a predetermined path similarly with the drag operation.

At least one gesture for dividing the memo may be received, and when the gesture for dividing the memo is input by a plurality of times, the device 100 may perform an operation of dividing the memo by the frequency by which the gesture for dividing the memo has been input.

In operation S403, the device 100 may determine at least one reference line for dividing the memo based on the gesture received in operation S401. When the gesture received in operation S401 is a drag operation or a motion operation, the device 100 may determine a reference line based on a path on which the drag operation or the motion operation has been performed.

The reference line that may be determined according to the gesture may be a straight line, a curve, or a closed curve. The shape of the reference line is not limited to the above-described examples and may include various shapes. In the case where an object included in the memo exists in a three-dimensional space, the memo may be divided according to a reference plane instead of the reference line.

In operation S405, the device 100 may generate a new memo into which at least one object included in the memo, which is a division object, may be inserted. The device 100 may generate one or more new memos depending on the shape or the number of the reference lines. Depending on the gesture received in operation S401, some of objects included in the memo are left on the existing memo, that is, the memo, which is a division object, and the rest of the objects are deleted from the existing memo and then may be inserted into the one or more new memos generated in operation S405. In the following, to which memo objects included in the memo, which is a division object, are inserted may be determined based on the reference line, and the device 100 may insert objects of a divided memo into a new memo.

In operation S407, the device 100 may determine whether the reference line determined in operation S403 is located on an object of the memo. When the reference line is located on the object, and the device 100 divides the object according to the reference line and generates a divided memo, the object may be displayed such that the object is difficult to recognize visually. For example, since the text has a characteristic that the text is recognizable by a user by forming one letter or word, when the device 100 divides text according to a reference line existing on the text, the text may be displayed such that the text is difficult for a user to recognize.

Therefore, the device 100 may perform a memo dividing operation in consideration of whether the reference line is located on an object in operations S407 to S411.

In operation S409, in the case where the reference line is located on an object of the memo, the device 100 may divide at least one object into a plurality of groups based on the reference line. The device 100 may divide at least one object on a minimum division basis of an object.

The minimum division basis of the object may mean a minimum unit by which an object may be divided into a plurality of groups based on the reference line. For example, the minimum division basis may include at least one of a letter, a word, a sentence, a paragraph unit of text, an image file unit, and an object unit to which a hyperlink is set. For example, the device 100 may divide an object into a plurality of groups on a letter basis of text.

In the case where the memo includes handwriting content including at least one stroke, the device 100 may determine handwriting content forming one letter, a word, a sentence, or a paragraph by including a plurality of strokes as a minimum division basis. That is, the device 100 may determine at least one of a word, a sentence, and a paragraph unit of handwriting content as a minimum division basis of an object.

When the reference line is not located on the object, in operation S413, the device 100 may classify a plurality of objects into a plurality of groups according to the reference line without consideration of the minimum division basis of the object.

In operation S411, the device 100 may insert the objects divided or classified in operation S409 or S413 into at least one new memo generated in operation S405 or leave the objects divided or classified in operation S409 or S413 on the existing memo for each group. The groups may correspond to the at least one new memo generated in operation S405 and the existing memo, respectively.

As the memo dividing operation is performed, when an object included in the existing memo is inserted into a new memo and thus deleted from the existing memo, an empty region of the existing memo may expand. Therefore, the device 100 may adjust a display area of the existing memo in order to minimize the empty region according to the reference line.

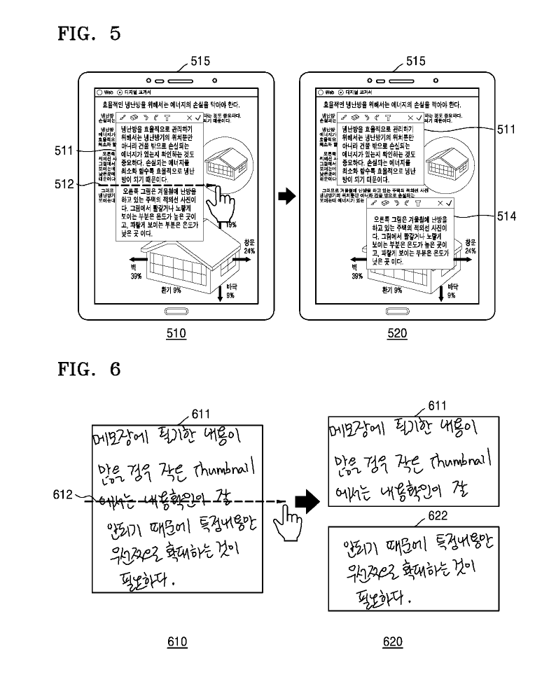

FIG. 5 is a view illustrating an example of dividing a memo according to an embodiment of the present disclosure.

Referring to 510 of FIG. 5, the device 100 may display an electronic document 515 and a memo 511 corresponding to the electronic document 515. When receiving a gesture for dividing the memo 511, the device 100 may determine a reference line 512 according to a gesture operation.

Referring to 520 of FIG. 5, the device 100 may generate memos divided based on the reference line 512. The device 100 may divide an object included in the memo 511 into two groups on a minimum division basis based on the reference line 512, and insert objects belonging to each group into a new memo 514 corresponding to the each group or leave the objects on the existing memo 511.

FIG. 6 is a view illustrating an example of a method of dividing a memo in the case where a reference line is located on an object according to an embodiment of the present disclosure.

Referring to 610 of FIG. 6, when a reference line 612 is located on an object, and the device 100 divides the object based on the reference line 612, divided objects may be displayed such that the objects are difficult to recognize visually.

Therefore, the device 100 according to an embodiment may divide an object of a memo 611 into a plurality of groups according to a minimum division basis of the object based on the reference line 612.

Referring to 620 of FIG. 6, in the case where the minimum division basis of the object is a letter basis of handwriting content including strokes, the device 100 may divide an object into two groups according to the minimum division basis of the object. A group including an object located on the upper end of the memo 611 may be left on the existing memo 611, and a group including an object located on the lower end of the existing memo 611 may be inserted into a new memo 622. When a portion of an object inserted into the new memo 622 is deleted from the existing memo 611, the device 100 may adjust a display area of the existing memo 611 in order to minimize an empty region of the expanded existing memo 611.

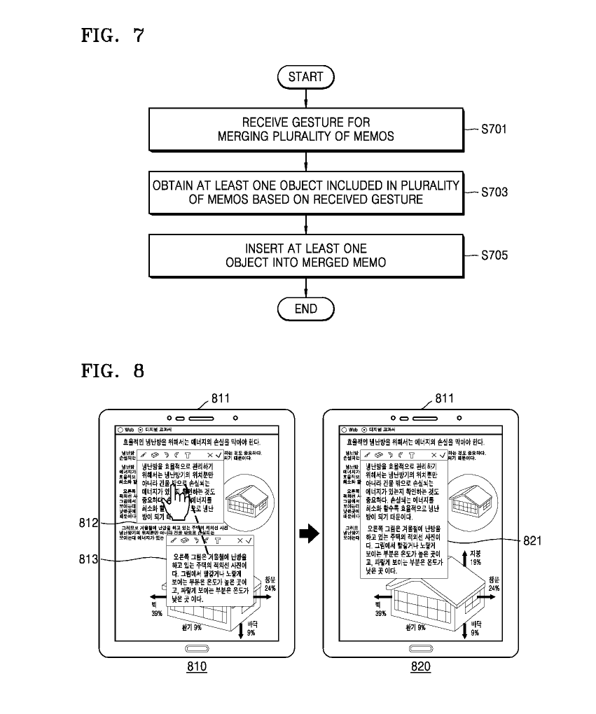

FIG. 7 is a flowchart illustrating a method of merging memos according to an embodiment of the present disclosure. According to an embodiment of FIG. 7, a memo that may be divided may include a memo that may be displayed by the device 100 together with the electronic document according to an embodiment of FIG. 2.

Referring to FIG. 7, in operation S701, the device 100 may receive a gesture for merging a plurality of memos. For example, the device 100 may receive a touch input that drags & drops one memo displayed by the device 100 onto another memo.

In operation S703, the device 100 may obtain at least one object included in the plurality of memos in order to merge memos based on the gesture received in operation S701.

In operation S705, the device 100 may insert the at least one object obtained in operation S703 into a merged memo. The merged memo may be determined as one of a plurality of memos to be merged or a newly generated memo depending on the gesture received in operation S701. In other words, the device 100 may perform an operation of merging a plurality of memos by inserting an object included in another memo into one of the plurality of memos to be merged, or inserting an object of the plurality of memos to be merged into a new memo. When the operation of merging memos is completed, a memo including the same content as that of the merged memo may be deleted.

FIG. 8 is a view illustrating an example of merging memos according to an embodiment of the present disclosure.

Referring to 810 of FIG. 8, the device 100 may display an electronic document 811 and a plurality of memos 812 and 813 corresponding to the electronic document 811. The device 100 may receive a gesture for merging the plurality of memos 812 and 813. The gesture for merging the plurality of memos 812 and 813 may include a touch input that drags & drops one memo 813 onto another memo 812 to merge.

Referring to 820 of FIG. 8, the device 100 may generate and display a memo 821 that merges the plurality of memos 812 and 813. The memo 821 in which the plurality of memos 812 and 813 merge may include at least one object included in the plurality of memos 812 and 813. The merged memo 821 may be a newly generated memo or one of the plurality of memos 812 and 813 depending on the gesture for merging memos.

Position information of the merged memo 821 may include relative position information of the plurality of memos 812 and 813 on the electronic document 811. For example, the position information of the merged memo 821 may include identification information of an object included in position information of the plurality of memos 812 and 813. The device 100 may update the position information of the merged memo 821 depending on change of the position of the merged memo 821 or a user input.

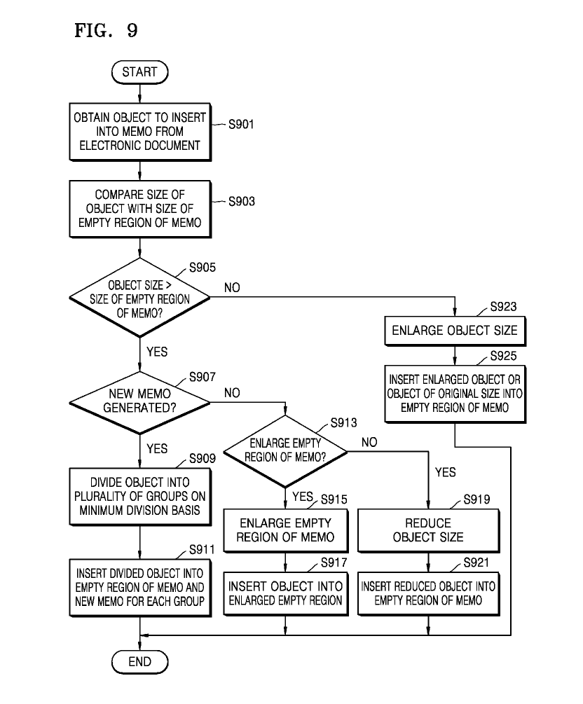

FIG. 9 is a flowchart illustrating a method of inserting an object into a memo according to an embodiment of the present disclosure.

Referring to FIG. 9, in operation S901, when receiving a user input for inserting an object into a memo, the device 100 may obtain the object to insert into the memo from an electronic document. For example, the device 100 may obtain an object that has received a user input among objects displayed on the electronic document. The device 100 may obtain an object to insert into a memo according to an input signal received from the outside or occurrence of a new event as well as the user input.

In operation S903, the device 100 may compare the size of the object obtained in operation S901 with the size of an empty region of a memo into which the object is to be inserted. Exemplarily, the device 100 may compare the size of the object with the size of the empty region of the memo and determine which size is greater. The empty region of the memo that may be compared in operation S903 may be determined according to a user input for inserting the object into the memo. For example, the empty region of the memo may be determined based on a ratio of the horizontal and vertical lengths of the object based on the position of the memo that has received a drop input among a drag & drop input for inserting the object into the memo.

In operation S905, when the size of the object is greater than the size of the empty region of the memo into which the object is to be inserted, the device 100 may determine whether to generate a new memo and insert the object into the new memo or insert the object into the empty region of the memo in operation S907.

To determine whether to generate the new memo, the device 100 may consider at least one of the entire size of the memo into which the object is to be inserted and the size of the empty region of the memo. For example, the device 100 may determine whether to generate the new memo based on the entire size of the memo into which the object is to be inserted and a degree by which the object reduces when the object is inserted into the empty region.

In the case where the device 100 enlarges the empty region of the memo and inserts the object into the enlarged empty region, when the size of the enlarged memo is greater than the display screen 110, a user's manipulation of scrolling, enlarging, or reducing the memo in order to display the enlarged memo is required. In contrast, in case of inserting the object into the new memo, the device 100 may display an object included in each memo with only a user manipulation of switching a displayed memo window. Therefore, the device 100 may determine whether to generate the new memo in consideration of the entire size of the memo into which the object is to be inserted.

In addition, in the case of not enlarging the size of the memo or enlarging the size of the memo that requires no scrolling, the device 100 may reduce the object and insert the same into the empty region of the memo. In the case where the device 100 reduces the object, the empty region of the memo may be smaller than the object, and the object may reduce such that the object is difficult to properly recognize. For example, in the case where the object reduces so that the object may be inserted into the empty region of the memo, text included in the object may reduce such that the text cannot be properly recognized. Therefore, the device 100 may determine whether to generate a new memo and insert the object into the new memo instead of reducing the entire object or a portion of the object and inserting the same into the empty region of the memo based on a reduction degree when the object is inserted into the empty region. The degree by which the object reduces that may serve as a basis in determining, at the device 100, whether to generate the new memo may be determined based on a minimum size of text or an image included in the object. The minimum size of the text or the image may be determined according to a user input or information set in advance, and determined in consideration of whether the degree corresponds to a size recognizable by a user.

In operation S909, the device 100 may divide the object into a plurality of groups according to a minimum division basis. Exemplarily, the device 100 may divide the object into a group to insert into the empty region of the memo and at least one group to insert into a new memo. For example, the device 100 may divide the object based on whether an object of each group inserted into the empty region of the memo or the new memo does not reduce or whether text or an image included in the object may reduce to a reference size or more and may be inserted.

For example, the device 100 may not divide the object into a plurality of groups but may insert the object obtained in operation S901 into a new memo depending on information set in advance or a user input.

In operation S911, the device 100 may insert the object divided in operation S909 into at least one of the empty region of the memo and the new memo for each group.

In the case where the device 100 determines not to generate the new memo in operation S907, the device 100 may enlarge the empty region of the memo and determine whether to insert an object into the empty region in operation S913. Exemplarily, the device 100 may determine whether to reduce the object and insert the same into the empty region of the memo, or whether to enlarge the empty region of the memo and insert the object into the empty region. In addition, the device 100 may determine whether to insert an object that has reduced to a minimum size of the memo into the enlarged empty region of the memo. For example, when reducing the object and inserting the same into the empty region of the memo, the device 100 may determine whether to reduce the object and insert the same based on whether the size of text or an image included in the object is a minimum size or more.

In the case where the device 100 determines to enlarge the empty region of the memo in operation S913, the device 100 may enlarge the empty region of the memo in operation S915. The device 100 may enlarge the empty region of the memo by enlarging the horizontal or vertical length of the memo.

In operation S917, the device 100 may insert the object into the enlarged empty region of the memo. The device 100 may reduce the object such that text or an image included in the object becomes a minimum size or more, and then insert the reduced object into the enlarged empty region of the memo.

In the case where the device 100 determines to reduce the size of the object and insert the same into the memo without enlarging the empty region of the memo in operation S913, the device 100 may reduce the size of the object in operation S919. As described above, the device 100 may determine whether to reduce the size of the object and insert the same into the empty region of the memo based on the minimum size of the text or the image included in the object. Also, the device 100 may insert the reduced object into the empty region of the memo in operation S921.

In the case where the size of the object is less than the empty region of the memo in operation S905, the device 100 may enlarge the size of the object in operation S923. Also, in operation S925, the device 100 may insert the object enlarged in operation S923 into the empty region of the memo. In addition, even in the case where the size of the object is less than the empty region of the memo, the device 100 may insert the object into the empty region of the memo without changing the size of the object.

Position information of each memo into which the object has been inserted may be determined or updated based on a position on the electronic document where the object inserted into each memo has been obtained according to the above-described method of inserting the object into the memo. For example, position information of the memo may include identification information or coordinate information of the object included in the electronic document that corresponds to the object inserted into the relevant memo. Position information of each memo is not limited thereto, and may be determined according to user setting, or determined according to a final position of a reference point of the memo.

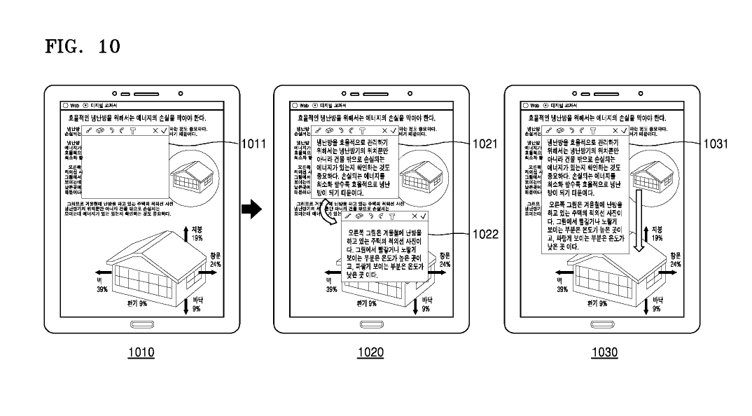

FIG. 10 is a view illustrating an example of a method of inserting an object into a memo according to an embodiment of the present disclosure.

Referring to 1010 of FIG. 10, the device 100 may display an electronic document and a memo 1011 corresponding to the electronic document. The device 100 may store at least one object in a clipboard according to a user input, and insert the at least one object stored in the clipboard into the memo 1011. Also, when receiving an input that drags & drops an object included in the electronic document onto the memo 1011, the device 100 may insert at least one object into the memo 1011.

The clipboard means a space that temporarily stores data, and may be generally used for performing operations such as cut, copy, paste, etc.

Referring to 1020 of FIG. 10, the device 100 may insert at least one object into a memo 1021 that receives an object insert request and a newly generated memo 1022. Exemplarily, when receiving an object insert request, the device 100 may determine whether to generate a new memo 1022, and in case of generating the new memo 1022, the device 100 may classify or divide at least one object into a plurality of groups. Also, the device 100 may insert the objects classified or divided into the plurality of groups into the memo 1021 or the new memo 1022 corresponding to each group.

Referring to 1030 of FIG. 10, the device 100 may insert at least one object into the memo 1011 that has received an object insert request according to a user input. Exemplarily, the device 100 may compare the size of an object with the size of an empty region of the memo 1011 and determine whether to enlarge the size of the empty region of the memo 1011. The device 100 may enlarge the size of the empty region of the memo 1011 depending on the determined result, and insert at least one object into a memo 1031 whose empty region has been enlarged.

For example, in the case of inserting text included in the clipboard or text that has received a drag & drop input into the memo 1011, the device 100 may determine whether the size of the empty region of the memo 1011 is sufficient to receive the text based on the number of letters included in the text. When the size of the empty region of the memo 1011 is not sufficient to receive the text, the device 100 may generate the new memo 1022, or enlarge the empty region of the memo 1011 in a horizontal direction or a vertical direction. The device 100 may classify texts into two groups and sequentially insert texts included in each of the groups into the memos 1021 and 1022. Alternatively, the device 100 may insert texts into a memo whose empty region has been enlarged. Alternatively, the device 100 may reduce texts to a minimum size or more and insert the same into the memo whose empty region has been enlarged.

The memos 1021, 1022, and 1031 into which an object has been inserted may further include position information of the electronic document including an object inserted into each of the memos or identification information of the object as position information, or update the position information or the identification information.

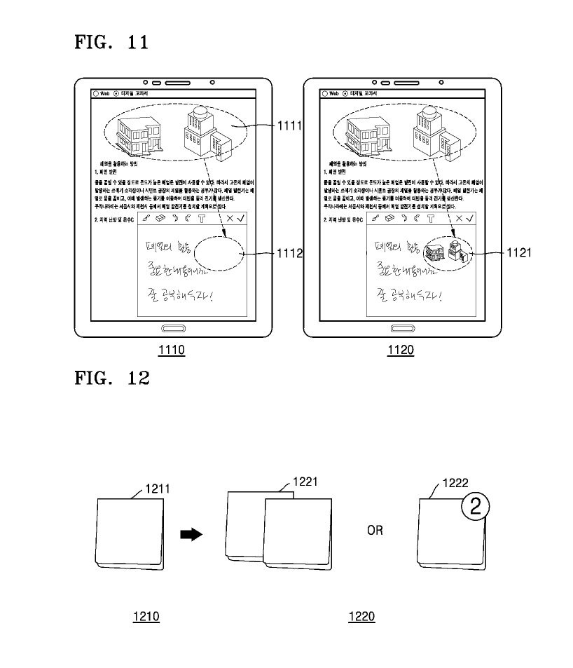

FIG. 11 is a view illustrating an example of inserting an object into a memo according to an embodiment of the present disclosure.

Referring to 1110 of FIG. 11, the device 100 may compare the size of an object 1111 to insert into a memo with the size of an empty region 1112 of the memo into which the object 1111 is to be inserted. The empty region 1112 of the memo may be determined based on the shape of the object 1111. For example, the empty region 1112 of the memo having a rectangular shape may be determined based on a ratio of horizontal and vertical lengths of the object 1111.

Referring to 1120 of FIG. 11, since the size of the object 1111 is greater than the empty region 1112 of the memo, the device 100 may reduce the object 1111 and insert the same into the inside 1121 of the empty region 1112 of the memo. In addition, the device 100 may enlarge the empty region 1112 of the memo while reducing the size of the object 1111 to a minimum size or more, and insert the object 1111 into the empty region 1112 of the memo. The device 100 may enlarge the empty region 1112 of the memo maximally, and then reduce the size of the object 1111 to the minimum size or more based on the empty region 1112 of the memo.

FIG. 12 is a view illustrating an example of displaying a memo icon according to an embodiment of the present disclosure.

Referring to 1210 of FIG. 12, a memo corresponding to an electronic document may be displayed as a memo icon 1211 on the electronic document.

Referring to 1220 of FIG. 12, in the case where the device 100 inserts objects divided into two groups into a plurality of memos like the embodiment illustrated in 1020 of FIG. 10, the device 100 may display two memo icons 1221 representing that the plurality of memos exist with respect to objects located on the same position or the same object. In addition, the device 100 may display a memo icon 1222 including the number of memos that exists with respect to the objects located on the same position or the same object instead of the two memo icons 1221.

Though the above description has been made by using the embodiment in which the electronic document and the memo corresponding to the electronic document are displayed together, hereinafter description is made by using an embodiment of a memo collected view mode that collects and views at least one memo.

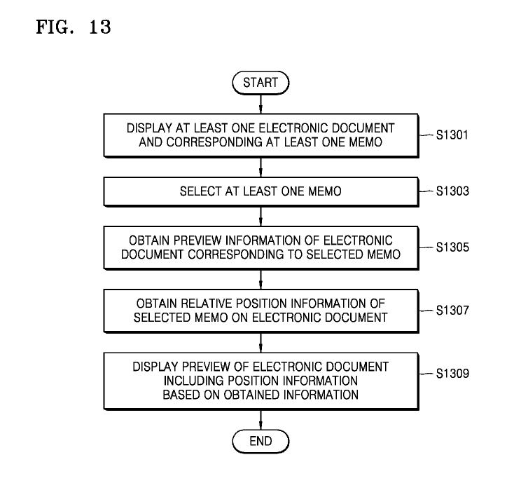

FIG. 13 is a flowchart illustrating a method of displaying a memo and an electronic document corresponding to the memo according to an embodiment of the present disclosure.

Referring to FIG. 13, in operation S1301, the device 100 may display at least one memo corresponding to at least one electronic document. For example, the device 100 may display one or more memos, and an electronic document corresponding to a memo may not be displayed together. Hereinafter, collecting at least one memo and displaying the memo mainly is referred to as the memo collected view mode. For example, in case of displaying a plurality of memos in the memo collected view mode, the device 100 may display the plurality of memos aligned in the form of a list or a thumbnail grid on one screen.

In operation S1303, the device 100 may select at least one memo from one or more memos displayed in operation S1301 according to a user input. For example, the device 100 may select a memo displayed on a region on which hovering or a touch input is detected. The device 100 may select a plurality of memos together by the frequency by which the hovering or the touch input is detected. The memo selection method is not limited to the user input, and the device 100 may select at least one memo by using various methods including information received from the outside or a method of selecting a memo according to information set in advance.

In operation S1305, the device 100 may obtain preview information for previewing an electronic document corresponding to the memo selected in operation S1303. For example, the preview information of the electronic document may include image information obtained by capturing the electronic document corresponding to the selected memo. The image information obtained by capturing the electronic document may include not only the image obtained by capturing the electronic document but also information related to the electronic document such as a filename and position information of the electronic document.

In operation S1307, the device 100 may obtain relative position information of the selected memo on the electronic document.

In operation S1309, the device 100 may display a preview of the electronic document including the position information obtained in operation S1307. That is, the device 100 may display the preview of the electronic document on which the position information of the memo is displayed. Exemplarily, the device 100 may display the preview of the electronic document including an entire or partial region of the electronic document based on the position information obtained in operation S1307. The device 100 may display a partial region of the electronic document based on the position information of the selected memo, considering that the preview of the electronic document may be displayed on a partial region of the display screen 110 and thus objects of the electronic document may reduce such that the objects are difficult for a user to recognize. The device 100 may display the objects of the electronic document in a size that is recognized by a user in a limited region by displaying a partial region of the electronic document as a preview instead of displaying the entire region of the electronic document.

In the case where the position information of the memo includes coordinate information, the device 100 may display a preview of the electronic document including a partial region of the electronic document based on the coordinate information on the electronic document. Also, in the case where the position information of the memo includes identification information of an object, the device 100 may display a preview of the electronic document including a partial region of the electronic document based on the object included in the electronic document.

According to an embodiment of the present disclosure, the device 100 may not obtain relative position information of the memo on the electronic document, and may display a preview of the electronic document on which the position information of the memo is not displayed in operation S1309. In addition, the device 100 may display a preview of another region of the electronic document besides the currently displayed region of the electronic document in the region on which the preview of the electronic document is displayed according to a user input.

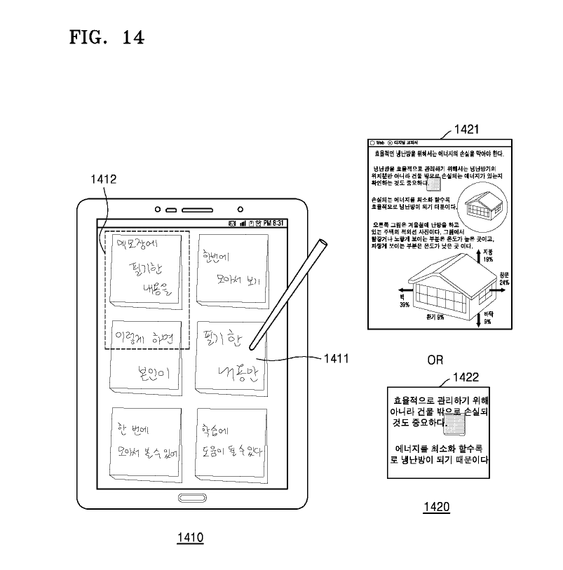

FIG. 14 is a view illustrating an example of displaying a preview of an electronic document according to an embodiment of the present disclosure.

Referring to 1410 of FIG. 14, the device 100 may display at least one memo. The device 100 may display a preview of an electronic document corresponding to a memo 1411 selected according to a user input from one or more memos displayed by the device 100.

The preview of the electronic document may be displayed on a partial region 1412 of the display screen 110 of the device 100 depending on preview information of the electronic document corresponding to the memo 1411 selected according to the user input.

Referring to 1420 of FIG. 14, an example of the preview of the electronic document that may be displayed on the partial region 1412 of the display screen 110 of the device 100 is illustrated.

The device 100 may display a preview of the entire electronic document 1421 corresponding to the selected memo 1411 or a preview of a partial region of the electronic document 1422 that is based on the position information of the selected memo 1411 on the partial region 1412 of the display screen 110. The position information of the selected memo 1411 may be displayed as a memo icon in the preview of the electronic document as illustrated.

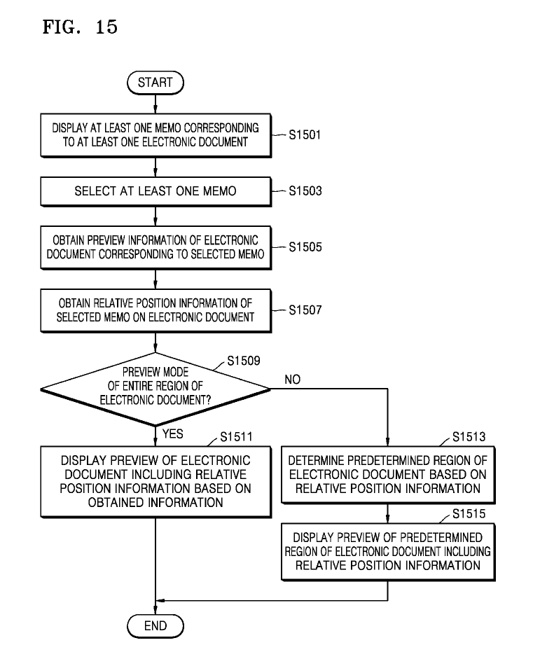

FIG. 15 is a flowchart illustrating a method of displaying a preview of an electronic document according to an embodiment of the present disclosure.

Referring to FIG. 15, in operation S1501, the device 100 may display at least one memo corresponding to at least one electronic document on the display screen 110. The at least one memo that may be displayed on the display screen 110 may include identification information regarding the electronic document that corresponds to the memo and position information of the memo on the electronic document. According to an embodiment of the present disclosure, the device 100 may collect one or more memos and display the same on the display screen 110 in a memo collected view mode.

In operation S1503, the device 100 may select at least one memo from the one or more memos displayed on the display screen 110 in operation S1501. For example, when receiving hovering, the device 100 may select a memo.

Also, in operation S1505, the device 100 may obtain preview information for displaying the preview of the electronic document corresponding to the memo selected in operation S1503. At least one electronic document corresponding to the selected memo may exist, and the device 100 may obtain preview information of the at least one electronic document and display a preview of the at least one electronic document.

In operation S1507, the device 100 may obtain relative position information of the memo selected in operation S1503 on the electronic document. In the case where a plurality of electronic documents corresponding to the selected memo exist, the device 100 may obtain a plurality of position information.

In operation S1509, the device 100 may determine whether a mode of the device 100 is a mode of previewing an entire region of an electronic document.

When the mode is the mode of previewing the entire region of the electronic document as a result of the determination in operation S1509, in operation S1511, the device 100 may display a preview of the entire region of the electronic document including the position information of the memo based on the position information obtained in operation S1507. For example, the device 100 may display the position of the memo on the electronic document in the form of a memo icon in the region that displays the preview of the entire region of the electronic document. The device 100 may obtain the position information of the memo for the plurality of electronic documents corresponding to the selected memo, and display previews of the plurality of electronic documents.

When the mode is a mode of previewing a partial region of the electronic document as a result of the determination in operation S1509, the device 100 may determine a predetermined region of the electronic document to display on a partial region of the display screen 110 in operation S1513 based on the position information obtained in operation S1507. For example, the device 100 may determine the predetermined region of the electronic document so that text or an image may be displayed in a minimum size or more in the partial region of the display screen 110.

In operation S1515, the device 100 may display a preview for the predetermined region of the electronic document determined in operation S1513 including the position information obtained in operation S1507. For example, the device 100 may display the preview for the predetermined region of the electronic document in which a memo icon representing the position information of the memo is displayed.

In addition, when receiving a user input with a preview of the electronic document displayed, the device 100 may display a page of the electronic document that has been displayed as the preview over the entire screen. Also, the memo selected in operation S1503 may be displayed together with the electronic document. In other words, the device 100 may end the memo collected view mode, and display the electronic document that has been displayed as the preview like the screen illustrated in FIG. 1.

For example, the device 100 may display a preview of the electronic document in operation S1511 or S1515 by selecting the memo in operation S1503 by using hovering. Also, when receiving a touch input for the memo selected by the hovering, the device 100 may display a page of the electronic document that has been displayed as the preview over the entire screen.

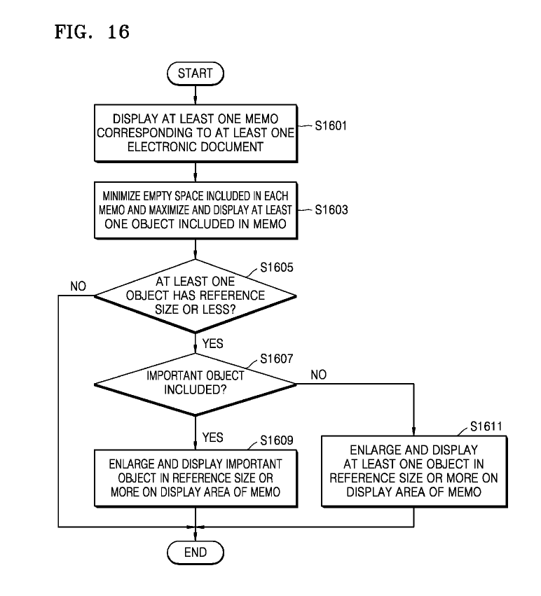

FIG. 16 is a flowchart illustrating a method of displaying a memo including an object according to an embodiment of the present disclosure. The memo that may be displayed according to the embodiment of FIG. 16 may include a memo that may be displayed together with the electronic document by the device 100 according to the embodiment of FIG. 2, and a memo that may be displayed according to the embodiment of FIG. 13.

Referring to FIG. 16, in operation S1601, the device 100 may display at least one memo corresponding to at least one electronic document on the display screen 110. The at least one memo that may be displayed on the display screen 110 may include at least one of identification information regarding an electronic document corresponding to each memo and position information of the each memo on the electronic document. According to an embodiment of the present disclosure, the device 100 may collect and display one or more memos in a memo collected view mode, or display at least one memo corresponding to the electronic document together with the electronic document.

In operation S1603, the device 100 may minimize an empty space included in a memo displayed on the display screen 110 and maximize at least one object included in the memo.

In operation S1605, the device 100 may determine whether at least one object maximized in operation S1603 is displayed in a reference size or less. For example, in the case where the object is text, a reference size of the object may be determined based on whether the text has a size that is recognizable by a user.

In the memo collected view mode, since a plurality of memos may be simultaneously displayed on one screen, a region in which each of the memos may be displayed is limited. Therefore, according to an embodiment of the present disclosure, the device 100 displays the memos in which each object is enlarged around an important object, so that a user may easily recognize content of each memo.

When determining that the at least one object has the reference size or less in operation S1605, in operation S1607, the device 100 may determine whether a memo including an important object is displayed on the display screen 110. The important object may include an object including a drawing or an image, or an object to which a hyperlink has been set. The important object may be set in advance according to a user input, or determined according to a predetermined algorithm for recognizing the important object. The important object may be one of text, handwriting content including strokes, and an image, and is not limited thereto. The important object may include various types of content.

When determining that the memo including the important object is displayed on the display screen 110 as a result of the determination in operation S1607, the device 100 may enlarge the important object in the reference size or more and display the same in a display area of the memo in operation S1609. Therefore, since the device 100 enlarges and displays the important object in the reference size or more, a user may recognize content of each memo around the important object.

When determining that the memo including the important object is not displayed on the display screen 110 as a result of the determination in operation S1607, the device 100 may enlarge and display at least one object among objects included in the memo in the reference size or more in the display area of the memo in operation S1611. Therefore, the device 100 enlarges and displays at least one object in the reference size, which is a size that is recognizable by a user, so that the user may recognize a portion of the content of each memo.

Meanwhile, when determining that the at least one object is not displayed in the reference size or less in operation S1605, the device 100 may display the at least one object without changing the size of the at least one object included in the memo. When the at least one object is not displayed in the reference size or less, the device 100 may consider that the at least one object included in the memo is displayed in a size that is recognizable by a user and display the at least one object without changing the size of the at least one object.

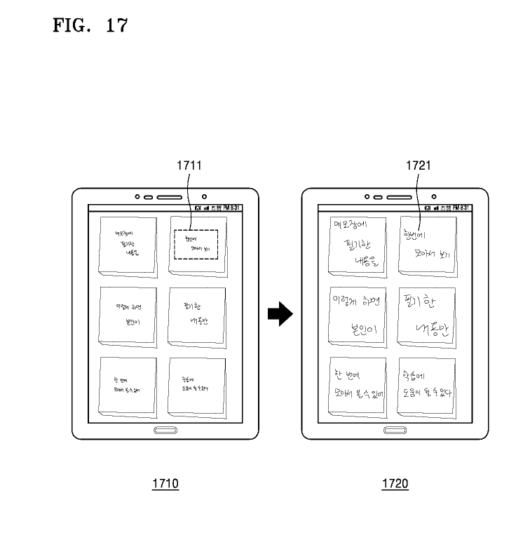

FIG. 17 is a view illustrating an example of displaying a memo according to an embodiment of the present disclosure.

Referring to 1710 of FIG. 17, the device 100 may identify a region 1711 in which an object of a memo is displayed.

Referring to 1720 of FIG. 17, the device 100 may minimize an empty region of the memo and maximize the region 1711 in which the object of the memo is displayed and display (1721) the same.

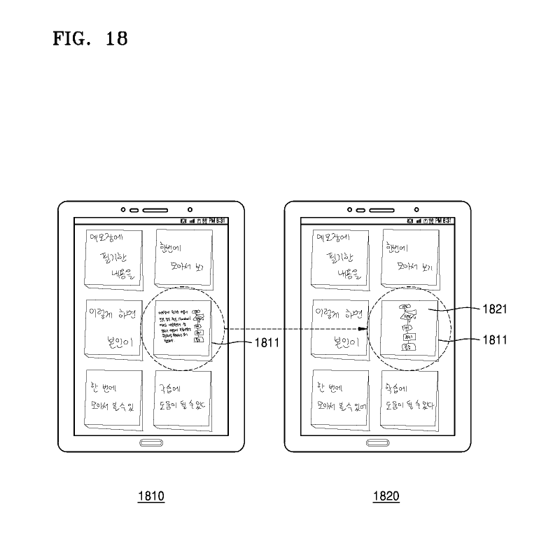

FIG. 18 is a view illustrating an example of displaying a memo including an important object according to an embodiment of the present disclosure.

Referring to 1810 of FIG. 18, the device 100 may identify a memo 1811 in which an object included in the memo 1811 is displayed in a reference size or less. The memo 1811 includes handwriting content including a plurality of strokes, and a reference size of the handwriting content may be determined based on whether the size of the handwriting content is a size that is recognizable by a user.

Referring to 1820 of FIG. 18, the device 100 may enlarge and display an important object in the reference size or more in the memo 1811 including an object displayed in the reference size or less. The important object of the memo 1811 may be determined as an object 1821 identified as a drawing among handwriting content included in the memo 1811. The device 100 may determine the important object 1821 according to a predetermined algorithm for identifying whether an object is a drawing among the handwriting content. Alternatively, the device 100 may determine the important object 1821 according to a user input. In the case where objects included in the memo 1811 are displayed in the reference size or less, the device 100 may allow a user to easily recognize the memo 1811 by displaying the important object 1821 mainly in the reference size or more.

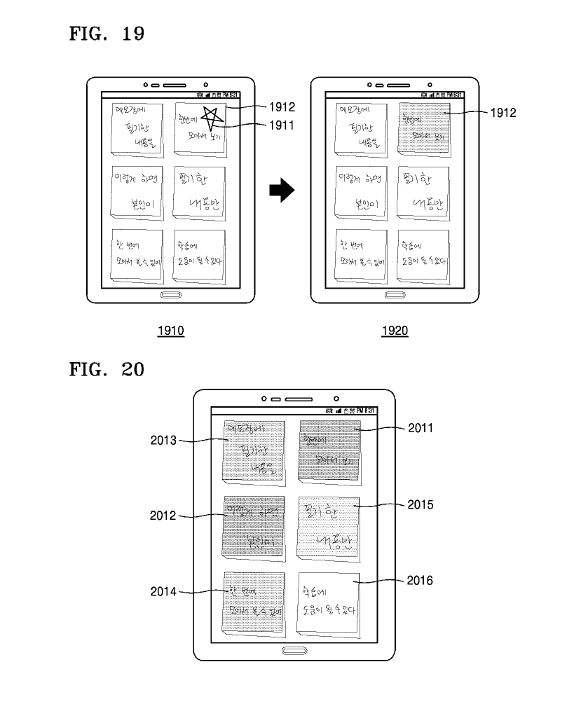

FIG. 19 is a view illustrating an example of displaying a memo including an important mark according to an embodiment of the present disclosure.

Referring to 1910 of FIG. 19, the device 100 may identify a memo 1912 including an importance mark 1911. The importance mark 1911 may include special letters set so that they may be identified as importance marks among text, for example, letters such as *, !, and #. In addition, the importance mark may include shapes set so that they may be identified as importance marks among handwriting content including an image or strokes, for example, a star shape like the importance mark 1911, an exclamation mark, or a shape that is the same as a letter ‘important.’

Referring to 1920 of FIG. 19, the device 100 may display the memo 1912 including the importance mark 1911 so that the memo 1912 may be discriminated from other memos. For example, the device 100 may display a background of the memo 1912 by using color different from those of backgrounds of other displayed memos as illustrated in 1920 of FIG. 19. Therefore, the device 100 may allow a user to easily discriminate and recognize a memo including an importance mark by displaying the memo including the importance mark so that the memo may be discriminated from other memos.

The device 100 is not limited to displaying a background color of a memo so that the background color may be discriminated from those of other memos, but may display an appearance of a memo that may include color of text or handwriting content, or an outline, etc. included in the memo so that the appearance may be discriminated from those of other memos. That is, the device 100 may change and display the appearance of the memo including an importance mark so that the memo may be discriminated from other memos.

FIG. 20 is a view illustrating an example of displaying a memo according to an embodiment of the present disclosure.

Referring to FIG. 20, the device 100 may determine a background color of a memo according to a predetermined rule, and display at least one memo according to the determined background color. The device 100 is not limited to the background color of the memo, and may determine the appearance of a memo and display at least one memo according to the determined appearance.

For example, the device 100 may determine the background color of a memo based on a frequency by which the memo is selected by a user. As a frequency by which a memo is selected by a user is high, the device 100 may determine the background color of the memo as dark color. A frequency of memo selection that serves as a criteria determining a background color may be determined as an absolute value, and determined as a relative value between memos displayed by the device 100.

Some memos 2011 and 2012 are determined as having a highest frequency of user selection and thus displayed by using a background of darkest color. Some memos 2013 and 2014 are determined as having an intermediate frequency of user selection and thus displayed by using a background of dark color of an intermediate degree. Some memos 2015 and 2016 are determined as having a low frequency of user selection and thus displayed by using a background of relatively light color compared with the background colors of other memos.

Though a dark degree of the background color has been determined depending on the frequency of memo selection according to the above embodiment of the present disclosure, various embodiments of the present disclosure are not limited thereto and light and shadow, saturation, brightness, color, etc. of the background color may be determined depending on the frequency of memo selection. Also, various embodiments of the present disclosure are not limited to the background color, and a letter color or light and shadow, saturation, brightness, color, etc. of an outline may be determined depending on the frequency of memo selection. Also, various embodiments of the present disclosure are not limited to the frequency of memo selection, and the appearance of the memo may be determined according to a predetermined rule related to the memo.

In addition, though the description has been made based on a memo that may be displayed in the memo collected view mode according to the above embodiment, the appearance of a memo or a memo icon displayed together with an electronic document may be also determined according to a predetermined rule in an embodiment.

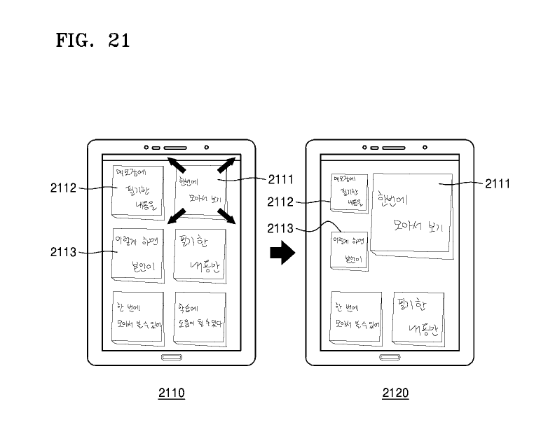

FIG. 21 is a view illustrating an example of enlarging and displaying a memo according to an embodiment of the present disclosure.

Referring to 2110 of FIG. 21, the device 100 may display a plurality of memos 2111, 2112, and 2113 on the display screen 110. The device 100 may receive a user input that requests the device 100 to enlarge one 2111 of the plurality of memos.

Referring to 2120 of FIG. 21, when one 2111 of the plurality of memos 2111, 2112, and 2113 displayed on the display screen 110 is enlarged, the device 100 may also adjust the sizes of the other memos 2112 and 2113 and display the same. Therefore, even when the size of one memo is enlarged, the device 100 may also adjust the sizes of the other memos 2112 and 2113 and display the same. Therefore, the device 100 may display the memos so that content of the other memos 2112 and 2113 may be displayed continuously without being hidden.

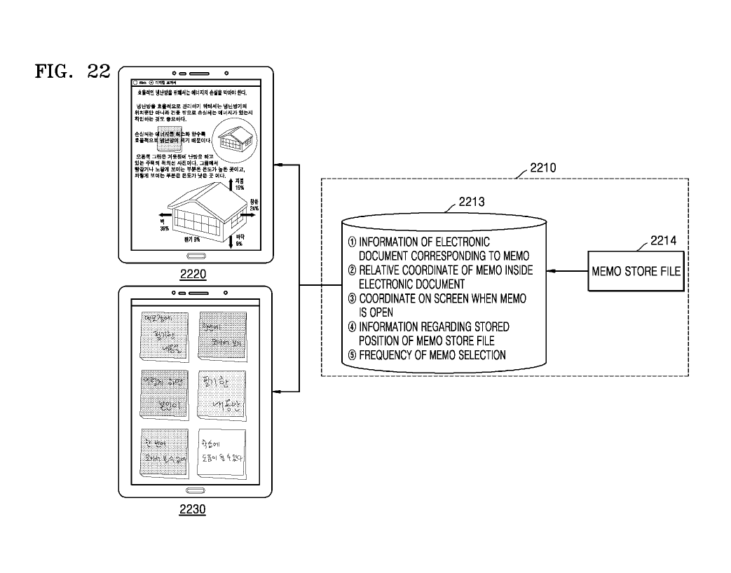

FIG. 22 is a block diagram explaining an example in which a memo and information regarding an electronic document are stored according to an embodiment of the present disclosure.

Referring to FIG. 22, the device 100 may obtain memo information 2210 including information for displaying an electronic document 2220 and a memo corresponding to the electronic document 2220 on the display screen 110 or information for displaying at least one memo in a memo collected view mode. The memo information 2210 may be stored in a memory of the device 100 or obtained from the outside.

The memo information 2210 may include a memo store file 2214 and memo display information 2213 for displaying a memo on the display screen 110. The memo store file 2214 may include information regarding objects included in at least one memo. Therefore, the device 100 may display a memo including an object on the display screen 110 based on information obtained from the memo store file 2214.

The information regarding the objects may include path information via which information of an object to display may be obtained in a memo or an object itself, for example, text or an image, a moving picture, and an audio file. The path information may include information regarding a path for obtaining an object from an electronic document or an external device.

The memo display information 2213 may include information for displaying a memo on the display screen 110. For example, the memo display information 2213 may include identification information of an electronic document corresponding to a memo, a relative coordinate of a memo inside an electronic document, a coordinate on the display screen when a memo is open, information regarding a stored position of a memo store file, and a frequency of memo selection as illustrated in FIG. 22. The memo display information 2213 is not limited thereto and may include various information for displaying a memo.

The identification information of the electronic document corresponding to the memo may include a stored position, a page number, etc. of the electronic document corresponding to the memo. In the case where the electronic document is a web page, the identification information of the electronic document may include uniform resource locator (URL) information of the web page. Based on identification information of an electronic document corresponding to a memo, when the electronic document corresponding to the memo is displayed, the device 100 may display the memo or a memo icon for the displayed electronic document. In addition, the device 100 may display a preview of the electronic document corresponding to the memo based on the identification information of the electronic document corresponding to the memo. For example, the device 100 may display the preview of the electronic document by generating a preview image from an electronic document file by using the identification information of the electronic document corresponding to the memo.

The relative coordinate of the memo inside the electronic document is relative position information of the memo on the electronic document, and maximum values of x and y of the coordinates may include coordinate information of a value (x,y) that may have the horizontal and vertical lengths of the electronic document. The device 100 may display a memo or a memo icon when displaying the electronic document as illustrated in 2220 of FIG. 22.

Coordinate information on the display screen 110 on which a memo may be displayed when the memo is open may include position information of the memo that may be displayed when a memo icon is selected. The device 100 may display a memo on which at least one object is displayed on the display screen 110 based on the coordinate information when the memo is open. The coordinate when the memo is open may be relative coordinate information on the electronic document, and is not limited thereto and may include absolute coordinate information based on the display screen 110.

Information regarding a stored position of the memo store file 2214 may include information regarding a position where each memo is stored. In the case where a memo is stored in a memory inside the device 100, the stored position information of the memo store file 2214 may include information regarding a store path inside the memory. In the case where a memo is information that is stored in an external device and may be obtained from the outside, stored position information of the memo store file 2214 may include URL information that may obtain the memo or position information of the external device that stores the memo.

The frequency of memo selection may include information regarding a frequency by which each memo is selected. For example, in the case where a memo icon is selected and content of a memo is displayed, or in the case where a memo that displays only a portion of content based on an important object is selected and entire content is displayed, the device 100 may determine that the memo is selected and update a frequency of memo selection. The device 100 may determine the background color of each memo depending on a frequency of selection of each memo corresponding to an electronic document displayed in the memo collected view mode illustrated in 2230 of FIG. 22 and display at least one memo.

In addition, the memo display information 2213 may further include information related to work history of a memo that may determine the appearance of the memo according to a predetermined rule as well as the frequency of memo selection.

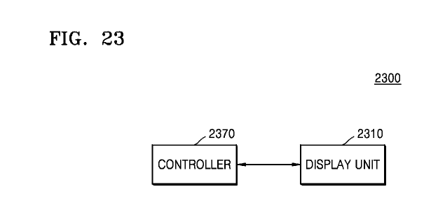

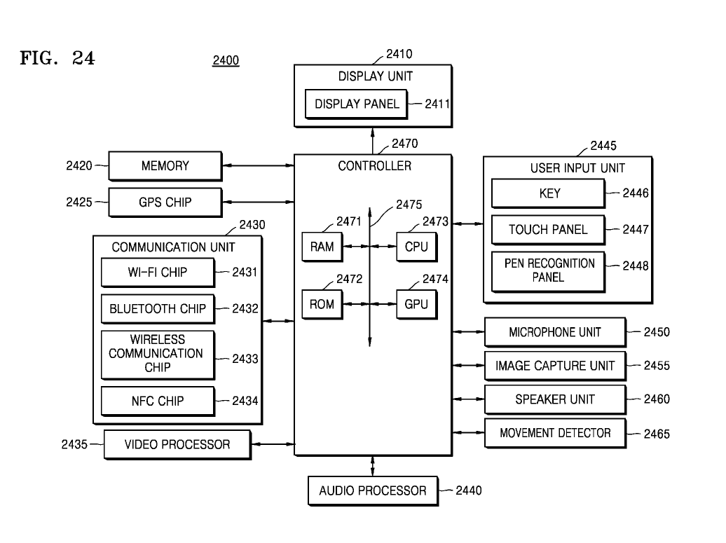

FIGS. 23 and 24 are block diagrams explaining the constructions of devices 2300 and 2400 according to various embodiment of the present disclosure. The devices 2300 and 2400 of FIGS. 23 and 24 may correspond to the device 100 of FIG. 1.

Referring to FIGS. 23 and 24, the constructions of the devices 2300 and 2400 are applicable to various types of devices such as a mobile phone, a tablet PC, a PDA, an MP3 player, a kiosk, an electronic frame, a navigation device, a digital television (TV), and wearable devices such as a wrist watch or a head-mounted display (HMD).

As illustrated in FIG. 23, according to an embodiment of the present disclosure, the device 2300 may include a controller 2370 and a display unit 2310. The controller 2370 and the display unit 2310 of FIG. 23 may correspond to a controller 2470 and a display unit 2410 of FIG. 24.

The display unit 2310 may display an electronic document and at least one memo corresponding to the electronic document.

The controller 2370 may obtain relative position information of a memo on the electronic document displayed on the display unit 2310, and control the display unit 2310 to display the memo on the electronic document based on the obtained relative position information depending on a display state of the electronic document.

However, all of the components illustrated in FIG. 23 are not essential components. The device 2300 may include more components than the illustrated components, and include less components than the illustrated components.

For example, as illustrated in FIG. 24, the device 2400 according to an embodiment may further include, besides the display unit 2410 and the controller 2470, a memory 2420, a global positioning system (GPS) chip 2425, a communication unit 2430, a video processor 2435, an audio processor 2440, a user input unit 2445, a microphone unit 2450, an image capture unit 2455, a speaker unit 2460, and a movement detector 2465.

Hereinafter, the above components are described in sequence.

The display unit 2410 may include a display panel 2411 and a controller (not shown) for controlling the display panel 2411. The display panel 2411 may be implemented by using various types of displays such as a liquid crystal display (LCD), an organic light-emitting diode (OLED) display, an active-matrix OLED (AM-OLED), and a plasma display panel (PDP). The display panel 2411 may be implemented such that the display panel 2411 is flexible, transparent, or wearable. The display unit 2410 may be provided as a touchscreen by coupling with a touch panel 2447 of the user input unit 2445. For example, the touchscreen may include an integral type module in which the display panel 2411 and the touch panel 2447 are coupled in a stacked structure.

The display unit 2410 according to an embodiment may display an electronic document and at least one memo corresponding to the electronic document under control of the controller 2470. In addition, the display unit 2410 may display a memo based on relative position information of the memo on the electronic document.

The memory 2420 may include at least one of an internal memory (not shown) and an external memory (not shown).

The internal memory may include, for example, at least one of a volatile memory (for example, dynamic random access memory (DRAM), static RAM (SRAM), synchronous DRAM (SDRAM), etc.), a non-volatile memory (for example, one time programmable read only memory (OTPROM), programmable ROM (PROM), erasable and programmable ROM (EPROM), electrically erasable and programmable ROM (EEPROM), mask ROM, flash ROM, etc.), a hard disk drive (HDD), and a solid state drive (SSD). According to an embodiment of the present disclosure, the controller 2470 may load an instruction or data received from at least one of the non-volatile memory or other components onto the memory and process the same. Also, the controller 2470 may store data received from or generated by other components in the non-volatile memory.

The external memory may include, for example, at least one of compact flash (CF), secure digital (SD), micro-SD, mini-SD, extreme digital (xD), and a memory stick.

The memory 2420 may store various programs and data used for an operation of the device 2400. For example, the memory 2420 may store at least one of the memo store file 2214, the memo display information 2213 for displaying a memo, and an electronic document temporarily or semipermanently.

The controller 2470 may control the display unit 2410 to display a portion of information stored in the memory 2420. In other words, the controller 2470 may display a portion of a memo or an electronic document stored in the memory 2420 on the display unit 2410. Alternatively, when a user gesture is performed on one region of the display unit 2410, the controller 2470 may perform a control operation corresponding to the user gesture.

The controller 2470 according to an embodiment may control the display unit 2410 to display an electronic document and at least one memo corresponding to the electronic document. The display unit 2410 may display a memo icon representing a memo or a memo on which an object is displayed according to relative position information on the electronic document. Also, the controller 2470 may control the display unit 2410 to display at least one memo in a memo collected view mode.

The controller 2470 may include at least one of a RAM 2471, a ROM 2472, a central processing unit (CPU) 2473, a graphic processing unit (GPU) 2474, and a bus 2475. The RAM 2471, the ROM 2472, the CPU 2473, and the GPU 2474 may be connected to each other via the bus 2475.

The CPU 2473 accesses the memory 2420 and performs booting by using an operating system (O/S) stored in the memory 2420. Also, the CPU 2473 performs various operations by using various programs, content, data, etc. stored in the memory 2420.

The ROM 2472 stores an instruction set, etc. for booting a system. For example, when a turn-on instruction is input and power is supplied, the CPU 2473 of the device 2400 may copy the O/S stored in the memory 2420 to the RAM 2471 according to an instruction stored in the ROM 2472 and execute the O/S to boot the system. When the booting is completed, the CPU 2473 copies various programs stored in the memory 2420 to the RAM 2471, and executes the programs copied to the RAM 2471 to perform various operations. When the booting of the device 2400 is completed, the GPU 2474 displays a user interface (UI) screen on a region of the display unit 2410. Exemplarily, the GPU 2474 may generate a screen on which an electronic document including various objects such as content, an icon, and a menu is displayed. The GPU 2474 calculates attribute values such as a coordinate value, a shape, a size, and color by which objects are to be displayed depending on a layout of the screen. Also, the GPU 2474 may generate a screen of various layouts including an object based on the calculated attribute values. The screen generated by the GPU 2474 may be provided to the display unit 2410, and displayed on each region of the display unit 2410.

The GPS chip 2425 may calculate the current position of the device 2400 by receiving GPS signals from GPS satellites. In the case of using a navigation program or in the case where the current position of a user is required, the controller 2470 may calculate the user position by using the GPS chip 2425. For example, the controller 2470 may control the display unit 2410 to display a memo corresponding to at least one of an electronic document currently being displayed and current position information by using the user position calculated by the GPS chip 2425.

The communication unit 2430 may communicate with various types of external devices according to various types of communication schemes. The communication unit 2430 may include at least one of a Wi-Fi chip 2431, a Bluetooth chip 2432, a wireless communication chip 2433, and a near field communication (NFC) chip 2434. The controller 2470 may communicate with various kinds of external devices by using the communication unit 2430. For example, the controller 2470 may receive a request for controlling a memo displayed on the display unit 2410 from an external device, and transmit results corresponding to the received request to the external device by using the communication unit 2430.

The Wi-Fi chip 2431 and the Bluetooth (BT) chip 2432 may perform communication by using a Wi-Fi scheme and a BT scheme, respectively. In the case of using the Wi-Fi chip 2431 and the BT chip 2432, the controller 2470 may transmit/receive various connection information such as a service set identifier (SSID) and a session key first and connect communication by using the various connection information, and then transmit/receive various information. The wireless communication chip 2433 means a chip that performs communication according to various communication standards such as Institute of Electrical and Electronics Engineers (IEEE), ZigBee, 3rd Generation (3G), 3rd Generation Partnership Project (3GPP), and long term evolution (LTE). The NFC chip 2434 means a chip that operates in an NFC scheme that uses 13.56 MHz among various RF-ID frequency bands such as 135 kHz, 13.56 MHz, 433 MHz, 860-960 MHz, and 2.45 GHz.

The video processor 2435 may process video data included in content received via the communication unit 2430 or content stored in the memory 2420. The video processor 2435 may perform various image processes such as decoding, scaling, noise filtering, frame rate conversion, and resolution conversion for video data. According to an embodiment of the present disclosure, in the case where a memo or an electronic document includes video data, the video data included in the memo or the electronic document may be reproduced according to a user input. For example, the video processor 2435 may process video data of content included in an electronic document or a memo displayed on the display unit 2410. Also, the display unit 2410 may display video data processed by the video processor 2435.

The audio processor 2440 may process audio data included in content received via the communication unit 2430 or content stored in the memory 2420. The audio processor 2440 may perform various processes such as decoding, amplification, or noise filtering for audio data. For example, the audio processor 2440 may process audio data of content included in an electronic document or a memo displayed on the display unit 2410. In addition, the audio processor 2440 may process audio data so that a sound effect representing that memo display changes according to a user input may be output.

When a reproduction program for multimedia content is executed, the controller 2470 may drive the video processor 2435 and the audio processor 2440 and reproduce the relevant content. The speaker unit 2460 may output audio data generated by the audio processor 2440. For example, the controller 2470 may process multimedia content included in an electronic document or a memo displayed on the display unit 2410 by using the video processor 2435 and the audio processor 2440.

The user input unit 2445 may receive various instructions from a user. The user input unit 2445 may include at least one of a key 2446, a touch panel 2447, and a pen recognition panel 2448. The device 2400 may display an electronic document or a memo according to a user input received from at least one of the key 2446, the touch panel 2447, and the pen recognition panel 2448.

The key 2446 may include various types of keys such as mechanical buttons and a wheel formed on various regions such as a front portion, a lateral portion, a rear portion, etc. of the appearance of the device 2400.

The touch panel 2447 may detect a user's touch input and output a touch event value corresponding to the detected touch input. In the case where the touch panel 2447 configures a touchscreen (not shown) by coupling with the display panel 2411, the touchscreen may be implemented by using various touch sensors such as a capacitive type sensor, a resistive type sensor, and a piezoelectric type sensor. The capacitive type touchscreen detects fine electricity caused to a user's body when a portion of the user's body touches the surface of the touchscreen by using a dielectric coated on the touchscreen and calculates a touch coordinate. The resistive type touchscreen includes two electrode plates built in the touchscreen, and when a user touches the touchscreen, the resistive type touchscreen detects that the upper and lower portions of the two electrode plates on the touched point contact each other and a current flows therethrough, and calculates a touch coordinate. A touch event that occurs on the touchscreen may be mainly generated by a person's hand, but may be generated even by an object including a conductive material.

The pen recognition panel 2448 may detect hovering or a touch input of a pen corresponding to an operation of a user's pen for touch (for example, a stylus pen and a digitizer pen), and output a detected pen hovering event or pen touch event. The pen recognition panel 2448 may be implemented in an electromagnetic resonance (EMR) method, for example, and may detect a touch input or hovering depending on intensity change of an electromagnetic field due to hovering or touch of a pen. The pen recognition panel 2448 may include an electronic signal processor (not shown) that sequentially provides an alternating current signal having a predetermined frequency to an electromagnetic induction coil sensor (not shown) having a grid structure and respective loop coils of the electromagnetic induction coil sensor. When a pen including a resonance circuit therein exists in the neighborhood of the loop coil of the pen recognition panel 2448, a magnetic field transmitted from a relevant loop coil generates a current that is based on mutual electromagnetic induction to the resonance circuit inside the pen. An induction magnetic field is generated from coils forming the resonance circuit inside the pen based on this current, and the pen recognition panel 2448 may detect an approach position or touch position of the pen by detecting this induction electromagnetic field from the loop coil that receives a signal. The pen recognition panel 2448 may be prepared below the display panel 2411 with a predetermined area, for example, an area that may cover a display area of the display panel 2411.

The microphone unit 2450 may receive user voice or other sounds and convert the same into audio data. The controller 2470 may use user voice input via the microphone unit 2450 during a telephone conversation operation, or convert the user voice into audio data and store the same in the memory 2420. For example, the controller 2470 may convert user voice input via the microphone unit 2450 into audio data, and incorporate the converted audio data into a memo and store the memo.

The image capture unit 2455 may capture a still image or a moving image depending on a user's control. The image capture unit 2455 may include a plurality of cameras such as a front camera and a rear camera.

In the case where the image capture unit 2455 and the microphone unit 2450 are prepared, the controller 2470 may perform a control operation according to user voice input via the microphone unit 2450 or a user motion recognized by the image capture unit 2455. For example, the device 2400 may operate in a motion control mode or a voice control mode. In the case where the device 2400 operates in the motion control mode, the controller 2470 may activate the image capture unit 2455 to capture a user, and trace a user's motion change to perform a control operation corresponding thereto. For example, the controller 2470 may display a memo or an electronic document depending on a user's motion input detected by the image capture unit 2455. In the case where the device 2400 operates in the voice control mode, the controller 2470 may operate in the voice control mode of analyzing user voice input via the microphone unit 2450, and performing a control operation according to the analyzed user voice. For example, the controller 2470 may analyze user voice input via the microphone unit 2450, and display a memo or an electronic document according to the analyzed user voice.

The movement detector 2465 may detect the movement of the device 2400. The device 2400 may be rotated or inclined in various directions. At this point, the movement detector 2465 may detect movement characteristics such as rotation direction and angle, and a slope by using at least one of various sensors such as a geomagnetic sensor, a gyro sensor, and an acceleration sensor. For example, the movement detector 2465 may receive a user input by detecting the movement of the device 2400, and display a memo or an electronic document according to the received user input.

Besides, though not shown in FIGS. 23 and 24, according to an embodiment of the present disclosure, the device 2400 may further include a universal serial bus (USB) port to which a USB connector may be connected, various external input ports for connecting with various external terminals such as a headset, a mouse, and a LAN, a digital multimedia broadcasting (DMB) chip for receiving and processing a DMB signal, and various sensors therein.

Names of the components of the device 2400 may change. Also, the device 2400 according to an embodiment may include at least one of the above-described components, and some of the components may be omitted or the device 2400 may further include additional components.

According to an embodiment of the present disclosure, a memo corresponding to an electronic device may be displayed on a display screen together with the electronic document according to relative position information of the memo on the electronic document.

According to an embodiment of the present disclosure, when a memo is selected, the device 2400 may display a preview of an electronic document corresponding to the selected memo.

A method according to the various embodiments described above may be implemented in the form of program commands executable via various components on a computer, and recorded on a non-transitory computer-readable recording medium. The non-transitory computer-readable recording medium may include a program command, a data file, a data structure, etc. independently or in combination. The program commands may be those that are especially designed and configured for the present disclosure, or may be those that are known and available to computer programmers skilled in the art.

Examples of the non-transitory computer-readable recording medium include magnetic recording media such as hard disks, floppy disks, and magnetic tapes, optical recording media such as compact disc ROMs (CD-ROMs) and digital versatile discs (DVDs), magneto-optical recording media such as floptical disks, and hardware devices such as ROMs, RAMs, and flash memories that are especially configured to store and execute program commands. Examples of the program commands include machine language codes that may be generated by a compiler, and high-level language codes that may be executed by a computer by using an interpreter.

The method of displaying a memo according to an embodiment may be implemented in the form of computer software. For example, a portion of operations of the method of displaying the memo may be configured as software modules having different functions, respectively, or the method of displaying the memo may be implemented in the form of one computer software. The method of displaying the memo according to an embodiment may be implemented as a program that belongs to an OS or application software.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of displaying a memo, the method comprising:
displaying an electronic document and a memo corresponding to the electronic document;
obtaining relative position information of the memo on the electronic document; and
displaying the memo on the electronic document based on the obtained relative position information depending on a display state of the electronic document.

2. The method of claim 1, wherein the relative position information of the memo comprises identification information of an object corresponding to the memo among objects included in the electronic document.

3. The method of claim 1, further comprising:
receiving a gesture for dividing the memo;
determining at least one reference line, and generating a divided memo according to the determined at least one reference line based on the received gesture;
when the at least one reference line is located on an object included in the memo, dividing the object into a plurality of groups based on the at least one reference line according to a minimum division unit of the object; and
inserting the divided object into the divided memo for each group based on the at least one reference line.

4. The method of claim 3, wherein the minimum division unit of the object comprises at least one of a letter of text and handwriting content, a word, a sentence, a paragraph unit, and an image file unit.

5. The method of claim 1, further comprising:
receiving a gesture for merging a plurality of memos;
obtaining at least one object included in the plurality of memos based on the received gesture; and
inserting the obtained at least one object into a second memo into which the plurality of memos merge.

6. The method of claim 1, further comprising:
obtaining an object to insert into the memo from the electronic document;
comparing a size of the object with a size of an empty region of the memo into which the object is insertable; and
adjusting at least one of the size of the memo and the size of the object such that the object is inserted into the memo based on a result of the comparing, and inserting the object into the memo.

7. The method of claim 1, further comprising:
obtaining an object to insert into the memo from the electronic document;
comparing a size of the object with a size of an empty region of the memo into which the object is insertable;
generating a new memo based on a result of the comparing, and dividing the object into a plurality of groups according to a minimum division unit of the object; and
inserting the divided object into the empty region of the memo and the new memo for each group.

8. The method of claim 1, further comprising:
obtaining an object to insert into the memo from the electronic document; and
inserting the obtained object into the memo,
wherein position information of the memo comprises identification information of an object of the electronic document that corresponds to the inserted object.

9. The method of claim 1, further comprising:
obtaining an object to insert into the memo from the electronic document;
comparing a size of the object with a size of an empty region of the memo into which the object is insertable;
adjusting a size of the object based on the size of the empty region of the memo; and
inserting the size-adjusted object into the empty region of the memo.

10. A non-transitory computer-readable recording medium having recorded thereon a program for implementing the method of displaying the memo of claim 1.

11. A method of displaying a memo, the method comprising:
displaying a memo corresponding to at least one electronic document;
selecting the memo;
obtaining preview information of an electronic document that corresponds to the selected memo;
obtaining relative position information of the selected memo on the electronic document; and
displaying a preview of the electronic document comprising the relative position information based on the obtained preview information.

12. The method of claim 11, wherein the displaying of the preview comprises:
determining a predetermined region of the electronic document based on the relative position information; and
displaying a preview for the determined predetermined region of the electronic document comprising the relative position information.

13. The method of claim 11, wherein the displaying of the memo comprises:
displaying the memo by minimizing an empty space included in the memo and maximizing at least one object included in the memo;
when the at least one object is displayed having a reference size or less, determining whether the memo comprises an important object; and
when the memo comprises the important object, enlarging the important object to the reference size or more and displaying the enlarged important object in a display area of the memo.

14. The method of claim 11, wherein the displaying of the at least one memo comprises:
when content included in the memo comprises an important mark, determining an appearance of the memo depending on the importance of the important mark; and
displaying the memo based on a result of the determining.

15. The method of claim 11, wherein the displaying of the at least one memo comprises:
obtaining a frequency of memo selection, which is a frequency by which the memo is selected and displayed; and
determining an appearance of the memo according to the obtained frequency of memo selection, and displaying the memo based on a result of the determining.

16. A non-transitory computer-readable recording medium having recorded thereon a program for implementing the method of displaying the memo of claim 11.

17. A device comprising:
a display unit configured to display an electronic document and a memo corresponding to the electronic document; and
a controller configured to:
obtain relative position information of the memo on the electronic document, and
control the display unit to display the memo on the electronic document based on the obtained relative position information depending on a display state of the electronic document.

18. The device of claim 17, wherein the relative position information of the memo comprises identification information of an object corresponding to the memo among objects included in the electronic document.

19. The device of claim 17, wherein the controller is further configured to:
receive a gesture for dividing the memo,
determine at least one reference line for dividing the memo based on the received gesture,
generate a divided memo according to the determined at least one reference line,
when the at least one reference line is located on an object included in the memo, divide the object into a plurality of groups based on the at least one reference line on a minimum division basis of the object, and
insert the divided object into the divided memo for each group based on the at least one reference line, and
wherein the display unit is further configured to display the divided memo.

20. The device of claim 17, wherein the controller is further configured to:
obtain an object to insert into the memo from the electronic document, and
insert the obtained object into the memo,
wherein the display unit is further configured to display the memo into which the object has been inserted, and
wherein the relative position information of the memo comprises identification information of an object of the electronic document that corresponds to the inserted object.

21. A device comprising:
a display unit configured to display a memo corresponding to at least one electronic document; and
a controller configured to:
select the memo, obtain preview information of the electronic document corresponding to the selected memo,
obtain relative position information of the selected memo on the electronic document, and
control the display unit to display a preview of the electronic document comprising the relative position information based on the obtained preview information.

22. The device of claim 21, wherein the controller is further configured to determine a predetermined region of the electronic document based on the relative position information, and
wherein the display unit is further configured to display a preview for the determined predetermined region of the electronic document comprising the relative position information.

23. The device of claim 21, wherein when at least one object is displayed having a reference size or less, the controller is further configured to determine whether the memo comprises an important object, and
wherein when the memo comprises the important object, the display unit is further configured to enlarge the important object in the reference size or more and display the enlarged important object in a display area of the memo.

24. The device of claim 21, wherein when content included in the memo comprises an importance mark, the controller is further configured to determine an appearance of the memo depending on the importance of the importance mark, and
wherein the display unit is further configured to display the memo based on a result of the determining.

25. The device of claim 21, wherein the controller is further configured to obtain a frequency of memo selection, which is a frequency by which the memo is selected and displayed, and determine an appearance of the memo depending on the obtained frequency of memo selection, and
wherein the display unit is further configured to display the memo based on a result of the determining.
